(19) United States
(12) Patent Application Publication
(10) Pub. No.: US 2003/0107651 A1
(43) Pub. Date: Jun. 12, 2003

(54) DIY photo print device

(76) Inventors: Jong-Yih Chen, Taipei (TW); Tah-Yeong Lin, Taoyuan Hsien (TW); Li-Kuang Chen, Taipei (TW); Jui-Ming Hsu, Hsinchu (TW); Chiou-Liang Wang, Chungli (TW)

Correspondence Address: J.C. Patents, Inc., 4 Venture, Suite 250, Irvine, CA, 92618, US

(21) Appl. No.: 10/026,174

(22) Filed: Dec. 20, 2001

(30) Foreign Application Priority Data
Dec. 11, 2001 (TW) 90221553

(51) Int. Cl. H04N 5/225

(52) U.S. Cl. 348/207.2

(57) ABSTRACT

The present invention provides a DIY photo print device suitable for the digital camera. The device comprises a billing box, a wireless image-receiving unit, a card data receiving unit, a processor, a monitor, and a photo printer. Wherein, the processor includes a plurality of control and IrDA protocol-processing programs to control the other units that are connected to the processor. The billing box provides a variety of payment methods. The monitor displays the two-way communication between the device and the user, and also displays the status of the image file transmission. The wireless image-receiving unit receives the optic signal of the image file, processes the photo-electronic transformation, and outputs an image file data to the processor. The card data receiving unit receives the image file data that is stored in a memory card. The processor controls the photo printer to print and output the photo.

### BACKGROUND OF THE INVENTION

1. Field of Invention

The present invention generally relates to a digital camera photo print device, and more particularly, relates to a digital camera do it yourself (DIY) photo print device that can be allocated in a convenience spot of the public area to provide the convenient digital camera photo print service to the users.

2. Description of Related Art

Since the techniques of the digital camera have been significantly improved in the recent years, not only the price of the digital camera reduced significantly, but also the resolution enhances continuously. In addition, the functions of the storage, transmission and editing are also improved significantly. Thus, the digital camera has a great advantage compared to the conventional camera that is not able to achieve those new functions. Along with the favorable factors, such as better performance, more reasonable price and the more and more add-ons functions, the digital camera is accepted by the public broadly, and thus becomes a popular product now.

The photo taken by the digital camera is stored in digital camera's memory unit such as the memory card in digital format. Each photo has an image file corresponding to it. The image file is generally such as an image file in the JPEG compression format. The digital image file must be printed out to have a real paper photo. In order to have the same quality as the conventional photo printer, the photo printer is used by user to print out the image file.

The digital camera allows users to print out the photo by themselves, and more particularly, to allow users to print out the photo via the wireless manner. Referring to FIG. 1, FIG. 1 schematically shows a conventional infrared wireless photo print system. The digital camera 100 transmits the image file that is taken by the digital camera 100 to a wireless photo-printing adaptor 102 via the infrared according to an infrared transmission protocol. The wireless photo-printing adaptor 102 transforms the image file format and outputs the transformed image data to an ink jet printer 104 to print out the photo.

The conventional photo print system mentioned above comprises a plurality of equipments, normally, the equipments are allocated in a fix location such as in home. The photo taken by the user in outside must be brought back to home to print out the photo. Therefore, the conventional photo print system mentioned above is limited by the time and the location. Whereas, the photo print is generally operated via the computer, the user has to know how to operate the computer to process the photo print. Furthermore, since the equipments of the photo print system are rather expensive, even the digital camera becomes more popular now, the high cost of the photo print equipments and the operation is not convenient to use are annoyances of the users and also become a problem that must be resolved by the vendors.

### SUMMARY OF THE INVENTION

To solve the problem mentioned above, the present invention provides a digital camera DIY photo print device. The device can be allocated in any convenience spot that is needed. The user is able to print out the photo taken by the digital camera in real time by paying a service charge and without the limitation of the operation.

The present invention provides a digital camera DIY wireless photo print device. The device comprises a billing box, a wireless image-receiving unit, a card data receiving unit, a processor, a monitor, and a photo printer. Wherein, the processor includes a plurality of control and IrDA protocol-processing programs to control the other units that are connected to the processor. The billing box provides a variety of payment methods. The monitor displays the two-way communication between the device and the user, and also displays the status of the image file transmission. The wireless image-receiving unit receives the optic signal of the image file, processes the photo-electronic transformation, and outputs an image file data to the processor. The card data receiving unit receives the image file data that is stored in a memory card. The processor controls the photo printer to print and output the photo.

In the mentioned above, the optic signal of the image file comprises a format that is complied with the transmission format of the IrDA protocol.

In the mentioned above, the optic signal of the image file comprises a format that is complied with the transmission format of the IrTran-P protocol.

In the mentioned above, the optic signal of the image file comprises a format that is complied with the transmission format of the Jet-send protocol.

In the mentioned above, the card data receiving unit comprises a CompactFlash (CF) card input member.

In the mentioned above, the card data receiving unit comprises a PCMCIA-ATA card input member.

In the mentioned above, the card data receiving unit comprises a microdrive input member.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a conventional infrared wireless photo print system;

FIG. 2 schematically shows the relationship between the IrDA and IrTran-P according to the present invention;

FIG. 3 schematically shows a block diagram of the data transmission and transformation between the image file of the digital camera and the computer windows according to the present invention;

FIG. 4 schematically shows a structure block diagram of the photo print system according to the present invention;

FIG. 5 schematically shows a functional block diagram of a DIY photo print system according to the present invention;

FIG. 6A schematically shows a three-dimensional structure diagram of a DIY photo print device according to the present invention; and

FIG. 6B schematically shows a cutaway view diagram of the DIY photo print device of FIG. 6A according to the present invention.

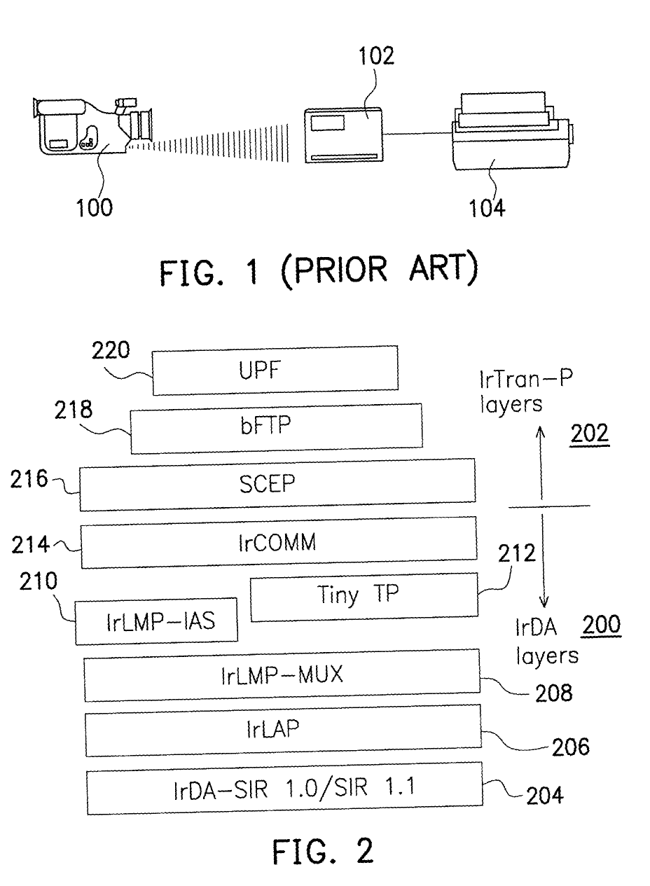

### DESCRIPTION OF THE PREFERRED EMBODIMENTS

One of the major characteristics of the present invention is a digital camera DIY photo print device. The device comprises a full set of the photo print system. The device can be allocated in any convenience spot that is needed. The user is able to print out the photo taken by the digital camera in real time by paying a service charge and without the limitation of the operation.

Generally, the photo print method of the digital camera includes wire print, card-insertion print, and the wireless print. Wherein, the wireless print is the most convenient transmission method. The digital camera that adopts the wireless print, for example, uses the infrared as the medium to transmit the digital photo data now. A plurality of communication protocols such as the Infrared Transfer Picture (IrTran-P) protocol and the Jet-send Protocol can be applied in the wireless transmission method. Wherein, the IrTran-P protocol is further configured above the Infrared Data Association (IrDA) protocol. Besides, the other type of the optic signal or the manner of the radio can also be applied to output the signal.

Regarding to the card-insertion method, the memory device used by the current digital camera are extension card and the microdrive. The extension cards are such as the CompactFlash (CF) card, the SmartMedia (SM) card, the Secure Digital (SD) card, the Memory Stick (MS), and the MultiMedia (MMC) card. Currently, the extension cards used by different vendors are not unified yet, and the microdrive is used by IBM only.

Generally, the photo print system dedicated to the individual or home must be equipped with all the equipments personally, and is generally allocated in a fix location. When the user is going outside, for example, like on traveling or on the business trip, it is not possible to carry the whole set of the equipments. The present invention thus provides a digital camera DIY wireless photo print device. The device can be allocated in the public area, like the sightseeing areas, supermarkets, super vendor stores, department stores, to provide the convenient photo print service, and thus the convenience is efficiently enhanced.

It is not adequate to use the wire connection in the public area, it is because the photo print device usage is quite heavy, thus makes the connectors and the wires subject to be easily damaged and broken. In addition, the signal connector specification of each vendor's digital camera is not the same, if the signal is transmitted via the connection wire, the customers have to prepare the connection wire by themselves, thus creates the unnecessary inconvenience. The method of wireless print can be accomplished by pressing a button remotely as long as within the safe distance to print out the photo. Thus, the wireless print is much convenient and also prevents the equipments from damage that caused by the incorrect usage.

The infrared wireless transmission method comprises the IrDA and IrTran-P data transmission protocols. The general digital camera uses the IrDA transmission format. The Jet-send protocol mentioned above is not popular, and only used by HP's product. An embodiment using the IrTran-P transmission protocol is provided below for description. FIG. 2 schematically shows the relationship between the IrDA and IrTran-P according to the present invention.

In FIG. 2, basically, the IrTran-P protocol layers 202 is above the IrDA protocol layers 200. The IrDA protocol layers 200 comprises an IrDA-SIR layer 204. The IrDA-SIR layer 204 has SIR 1.0 and SIR 1.1 two options; the transmission speed of the SIR 1.0 is 115.2 Kbps, whereas the transmission speed of the SIR 1.1 is 4.0 Mbps. On above, there is a Link Access Protocol (IrLAP) layer 206, a Link Management Protocol (IrLMP) layer 208, an Information Access Service layer 210, a Flow-control for a Multiplexed Channel (Tiny TP) layer 212, and a IrCOMM layer 214. Wherein, the IrCOMM layer 214 is used for the RS232 simulation. Whereas, the IrTran-P protocol layers 202 comprises a Simple Command Execute Protocol (SCEP) 216 for connection management, segmentation and reassemble, a Binary File Transfer Protocol (bFTP) 218, and an Uni-Picture Format (UPF) 220.

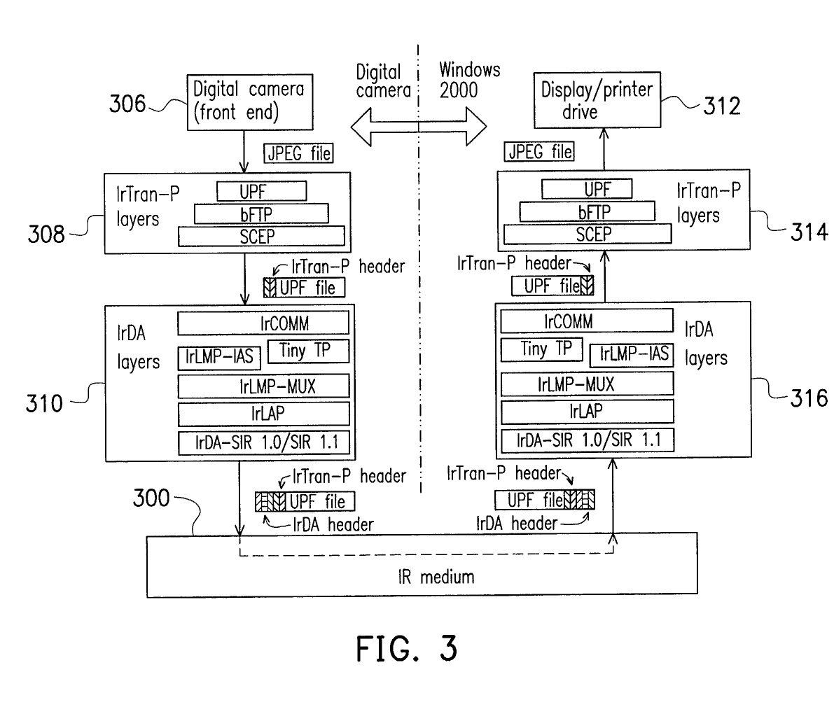

In addition, FIG. 3 schematically shows a block diagram of the data transmission and transformation between the image file of the digital camera and the computer windows according to the present invention. In FIG. 3, the transmission between the digital camera 302 and the computer windows 304 is via the infrared medium 300. In the portion of the digital camera 302, it comprises the digital camera (front end) 306 for capturing the JPEG image file, the JPEG image file is then sent to the first layer of the IrTran-P layers 308 to generate an UPF file after transformation, the UPF file has an IrTran-P header data. Then, the UPF file is sent to the IrDA layers 310 to transforms into an IrDA file, the IrDA header data is added. Afterwards, the IrDA file is transmitted to the computer via the infrared. The computer has a receiver to receive the IrDA image file and inputs the IrDA image file into an IrDA layers 316 that is inside the computer to recover the UPF image file. The UPF image file is subsequently sent to an IrTran-P layers 314, and transformed back a JPEG image file. The JPEG image file format is commonly used by the computer to display the image file. The JPEG image file is then sent to the Display/Printer drive 312 to display and print.

Although the current Windows 2000 supports the IrTran-P protocol, however, it only supports the receiving and does not support the transmitting function. Thus, the current Windows 2000 is not suitable to print the photo that is stored in the notebook computer.

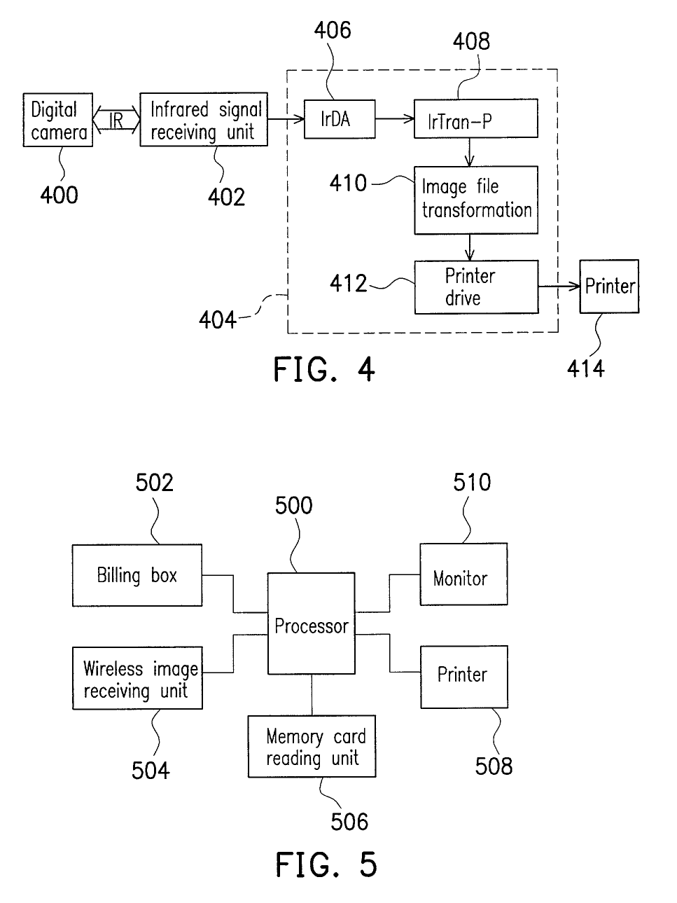

The DIY photo print system according to the present invention is able to transmit the JPEG image file to the computer for printing via the wireless or the card-insertion manner. If the card-insertion method is used, the photo print system is able to read the image file data of the image memory card directly. If the wireless method is used, the structure of the photo print system is shown in FIG. 4. In FIG. 4, the digital camera 400, for example, transmits the image file to the DIY photo print system by using the infrared in IrDA format. The photo print system is basically composed of three major phase functional blocks; they are the infrared signal receiving unit 402, the data process phase 404, and the print phase 414.

At first, an infrared signal receiving unit 402 that is included in the system transforms the optic signal into an electric signal. The format of the electric signal is descried as above and complies with the IrDA protocol in the present embodiment. The transformed electric signal is input to the IrDA functional block 406 to process the transformation, the detail flow of the transformation please referred to FIG. 3. Afterwards, The IrDA functional block 406 outputs the IrTran-P file to the IrTran-P functional block 408 to transform into the image file such as JPEG image file that can be displayed by general computer again. The JPEG image file must be transformed to the BMP bitmap format before printing. Thus, the JPEG image file is processed by the image file transformation 410 and then sent to the printer drive 412. The print drive 412 drives the printer 414 to print according to the content of the BMP image file.

The photo print working theory according to the description of the present invention mentioned above can be achieved by using the wireless and the card-insertion methods. The present invention integrates these two methods mentioned above into a single system, thus the system is convenient to be allocated in the public area. The user is able to transmit the image file easily to the DIY photo print system to print the photo via the wireless receiving interface member or the memory card reading member. FIG. 5 schematically shows a functional block diagram of a DIY photo print system according to the present invention.

The present invention comprises a processor 500, a billing box 502, a wireless image-receiving unit 504, a memory card reading unit 506, a printer 508, and a monitor 510. Wherein, the processor includes a plurality of control and IrDA protocol-processing programs to control the other units that are connected to the processor mentioned above. The billing box 502 is connected to the processor 500, provides a variety of the payment methods such as the coin-insertion or pay by credit card. After the user pays the charge via the billing box 502, the processor 500 displays some information such as some options on the monitor 510. Through the cooperation of the billing box 502, the processor 500 and the monitor 510, the user is able to have two-way communication with the photo print device. The monitor 510 is also able to display all the status of the operation and the status of the image file transmission.

The wireless image-receiving unit 504, receives the optic signal of the image file sent from the digital camera, the transmission is according to the selected transmission protocol. The wireless image receiving unit 504, after receiving the infrared signal, processes the photo-electronic transformation to transform the image file data into the image format that can be accepted by the general computer, such as the commonly used JPEG compression format. The image file data is subsequently sent to the processor 500. The processor 500 further controls the printer 508 to print and output the photo. Generally, the photo printer 508 accepts the BMP format, thus, the JPEG is first decompressed into the BMP format, and then is print via the halftone print technology cooperating with the printer control language.

The operation mentioned above is using the wireless method. The photo print system according to the present invention also supports the user to use the digital camera image file memory card. The memory card is read by the memory card reading unit 506 directly. Whereas, the specification of the memory cards are different for different vendors. The present embodiment, for example, provides two options, one is CF card reading, and the other is PCMCIA-ATA card reading. The reading format of the card can be changed according to the physical design, and the option for choosing is not limited to only two.

Herein, there is another advantage worth to note. If the user uses the card-insertion method to print the photo, since the image file is not transmitted by the infrared of the digital camera, the present photo print system is not limited to print the image file of the digital camera, any image file stored in the memory card can be printed as a photo. Thus, the system is suitable for the notebook computer or the personal digital assistance (PDA) that is easy to carry.

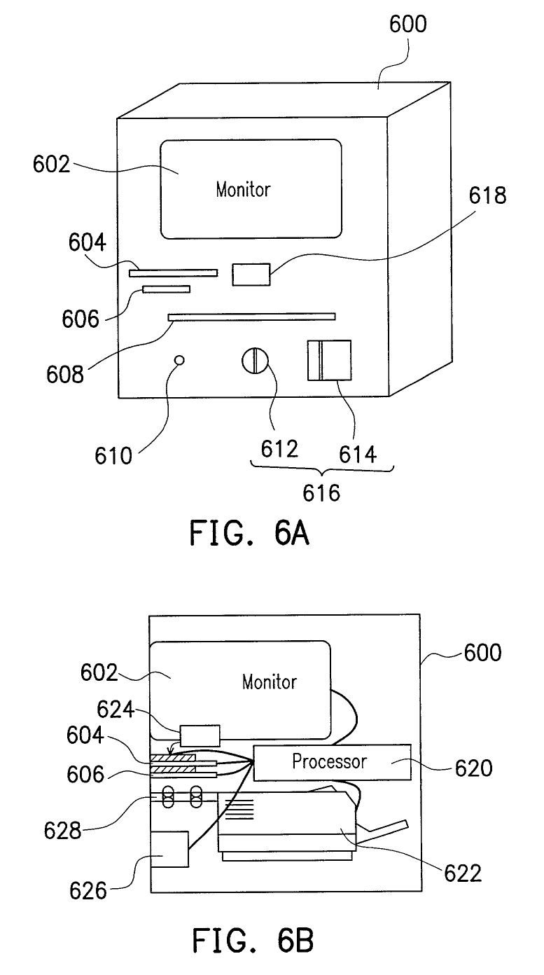

According to the DIY photo print system mentioned above, the system could be assembled as an independent device. FIG. 6A schematically shows a three-dimensional structure diagram of a DIY photo print device according to the present invention. FIG. 6B schematically shows a cutaway view diagram of the DIY photo print device of FIG. 6A according to the present invention. In FIG. 6A and FIG. 6B, a case 600 is used to assemble and lay up the photo print system within it. A processor 620 is allocated inside the case 600. A program is used to control the connected peripheral devices including the monitor 602, the photo printer 622, the wireless image-receiving unit 624, the memory card reading unit 604, 606, and the billing box 626. The case 600 has a screen window for monitor 602 to display information. The case 600, for example, also equips a camera placement mechanism (not shown in the diagram) that allows the digital camera to put on it to aim to the infrared window 618. The infrared window 618 also aims to the wireless image-receiving unit 624 to receive the infrared signal. In addition, corresponding to the billing box 626, the case 600 also equips a coin-insertion hole 612 and the pay by credit card member 614, or the member for the other payment method such as the other smart IC card or the prepaid card. The photo printer 622, for example, can be an ink jet printer. Besides, in order to protect the photo that is just printed out, a photo paper output guidance member 628, for example, including the roller and the paper guidance slot are also included. The cast 600 also equips a photo paper outlet 608 that is corresponding to the photo paper output guidance member 628. The photo pager output guidance member 628 and the photo paper outlet 608 can also be designed as hidden, and extends only when the photo is sent out.

If the card-insertion method is used, the present DIY photo print system further comprises a memory card reading unit such as a CF card interface member 604 and a PCMCIA card interface member 606.

In addition, the processor cooperates with the billing box ensures the user had paid successfully. Then, the processor controls the device into a standby mode. Besides, the system further comprises a power display 610 to indicate the information such as the photo print service is normal.

Since the device of the present invention can be allocated in the convenient spot for user to use. The user only have to pay a reasonable charge to print out the photo without having to prepare the whole set of the system. If the user encounters the situation of memory full, the image files can be print out first to release the memory space for further photograph.

The photo print device according to the present invention has the fullest function of the photo print. Thus, the device can be allocated in the convenient public area for user to print out the photo in real time. The user is able to print out the photo without having the computer professional knowledge.

The photo print device according to the present invention has the payment function that is convenient for user to use the system by paying the charge.

The photo print device according to the present invention utilizes the wireless transmission method, thus, is not limited to the output connector specifications of different vendors.

The photo print device according to the present invention comprises the card-insertion reading device, and the IrTran-P is allowed to apply to the digital camera, notebook computer, and personal digital assistance.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A DIY photo print device, the device can be allocated in an adequate location, and suitable for a user to print an image file, the image file can be transmitted by a digital camera either via a wireless method or a memory card, the photo print device comprises:
a processor, having a system program, to control a plurality of peripheral units that are connected to the processor listed below, the peripheral units comprises:
a billing box, provides a plurality of payment methods;
a wireless image-receiving unit, receives a signal of the image file that is sent from the digital camera, processes a transformation, and outputs an image file data to the processor;
a memory card reading unit, reads the image file data of the memory card directly;
a monitor, displays the two-way service communication between the processor and the user, and also displays a status of the image file process; and
a photo printer, the photo is controlled by the processor and used for printing the image file.

2. The DIY photo print device of claim 1, further comprises a case, the case comprises:
an infrared window;
a camera holder, allows the digital camera place into the camera holder, aims to the infrared window, outputs the optic signal of the image file to the wireless image-receiving unit;
a card-insertion slot, aims to the memory card reading unit;
a coin-insertion hole, provides one of the payment methods;
a pay by credit card member, provides one of the payment methods; and
a power display.

3. The DIY photo print device of claim 1, wherein the signal sent from the digital camera comprises an infrared using an IrDA protocol mode to output.

4. The DIY photo print device of claim 3, wherein the wireless image-receiving unit transforms the data into a computer image file format by using the IrDA protocol cooperating with an IrTran-P.

5. The DIY photo print device of claim 1, wherein the signal sent from the digital camera comprises an optic signal.

6. The DIY photo print device of claim 1, wherein the signal sent from the digital camera comprises a radio signal.

7. The DIY photo print device of claim 1, further comprises a photo paper output guidance member to output a photo that is print out.

8. The DIY photo print device of claim 7, wherein the photo paper output guidance member comprises a paper guidance slot and a roller member to protect the photo.

9. The DIY photo print device of claim 1, wherein the processor cooperates with the billing box ensures the user had paid successfully.

10. The DIY photo print device of claim 1, wherein the system program of the processor comprises controlling the device into a standby mode.

11. The DIY photo print device of claim 1, wherein the system program of the processor comprises controlling the device into a hibernation mode.

12. The DIY photo print device of claim 1, wherein the system program of the processor comprises a communication protocol.

13. The DIY photo print device of claim 1, wherein the photo printer comprises an optic photo printer.

14. The DIY photo print device of claim 1, wherein the adequate location where the wireless photo print device is allocated comprises a public area.

15. The DIY photo print device of claim 1, wherein the memory card reading unit comprises a CompactFlash card interface member.

16. The DIY photo print device of claim 1, wherein the memory card reading unit comprises a PCMCIA card interface member.

17. The DIY photo print device of claim 1, wherein the memory card reading unit is able to accept the input from the individual of a plurality of memory cards of the digital camera, the notebook computer, and the personal digital assistance.

18. A DIY photo print device, the device can be allocated in an adequate location, and suitable for a user to print an image file, the image file can be transmitted by a digital camera via a wireless method according to a data transmission protocol, the photo print device comprises:
a processor, having a system program, to control a plurality of peripheral units that are connected to the processor listed below, the peripheral units comprises:
a billing box, provides a plurality of payment methods;
a wireless image-receiving unit, receives a signal of the image file that is sent from the digital camera, processes a transformation of the data transmission protocol, and outputs an image file data to the processor;
a monitor, displays the two-way service communication between the processor and the user, and also displays a status of the image file process; and
a photo printer, the photo is controlled by the processor and used for printing the image file.

19. The DIY photo print device of claim 18, wherein the wireless method adopted by the digital camera comprises either an optic signal or a radio signal.

20. The DIY photo print device of claim 18, wherein the data transmission protocol adopted by the digital camera comprises an IrDA protocol and an IrTran-P protocol.
